(19) United States
(12) Patent Application Publication
(10) Pub. No.: US 2011/0089748 A1
(43) Pub. Date: Apr. 21, 2011

(54) WHEEL COVER ASSEMBLY

(76) Inventors: Paul Grill, Lansing, MI (US); Garry Van Houten, Middleville, MI (US)

(21) Appl. No.: 12/582,391

(22) Filed: Oct. 20, 2009

(51) Int. Cl. B60B 7/14

(52) U.S. Cl. 301/37.102

(57) ABSTRACT

A wheel assembly includes a wheel having a centrally-located aperture, a hub portion including lug bolt receiving apertures, a rim portion extending circumferentially about the wheel, and a web portion extending between the hub portion and the rim portion, wherein the hub, rim and web portions cooperate to form an outer surface, and a wheel cover having an inner surface facing the outer surface of the wheel, a central portion covering the centrally-located aperture of the wheel, a rim portion extending circumferentially about the cover, and a web portion extending between the central portion and the rim portion, wherein the central, rim and web portions comprise a single, integral piece and cooperate to form an outer surface of the cover member, and wherein the rim portion of the cover member radially overlaps the rim portion of the wheel such that the wheel cover and wheel cooperate to provide the aesthetic appearance of a single-piece wheel. The wheel assembly further includes an attachment assembly attached to the axle hub bolts and operably coupling the wheel cover member with the wheel, wherein the attachment assembly provides for an axially adjustment of the wheel cover member with respect to the wheel.

### BACKGROUND OF THE INVENTION

The present invention relates to a cover assembly for a wheel, and in particular to a cover assembly adapted for use with deep-well, dually-wheel arrangements typically utilized within heavy duty vehicles, such as semi-tractors, semi-tractor trailers, RV motor coaches, vehicles utilizing dually wheel configurations, super-single wheel replacing dually-wheel applications, and the like.

### SUMMARY OF THE INVENTION

One aspect of the present invention is to provide a wheel assembly for attaching to a vehicle hub assembly having an axle hub and a plurality of axle hub bolts extending axially from an end of the axle hub in a substantially circular pattern, the wheel assembly comprising a wheel having a centrally-located aperture for receiving an axle hub therethrough, a hub portion including a plurality of lug bolt-receiving apertures adapted to receive a plurality of lug bolts therein to secure the wheel assembly to an associated vehicle, a rim portion extending circumferentially about the wheel, and a web portion extending between the hub portion and a rim portion, wherein the hub portion, the rim portion and the web portion cooperate to form an outer surface of the wheel. The wheel assembly further comprises a wheel cover member having an inner surface facing the outer surface of the wheel, a central portion covering the centrally-located aperture of the wheel, a rim portion extending circumferentially about the cover member, and a web portion extending between the central portion and the rim portion of the cover member, wherein the central portion, the rim portion and the web portion of the wheel cover comprise a single, integral piece and cooperate to form an outer surface of the cover member, and wherein the rim portion of the cover member radially overlaps the rim portion of the wheel such that the wheel cover member and the wheel cooperate to form the aesthetic appearance of a single-piece wheel. The wheel assembly further comprises an attachment assembly attached to the axle hub bolts and operably coupling the wheel cover member with the wheel, wherein the attachment assembly provides axial adjustment of the wheel member with respect to the wheel.

Another aspect of the present invention is to provide a wheel cover assembly for covering a vehicle wheel and a vehicle hub assembly that includes an axle hub and a plurality of axle hub bolts extending axially from an end of the axle hub in a substantially circular pattern, the wheel cover assembly comprising a wheel cover member having an inner surface adapted to face an outer surface of a vehicle wheel, a central portion adapted to cover a centrally-located aperture of a wheel that receives an axle hub therethrough, a web portion circumscribing the central portion, and a rim portion extending circumferentially about the rim portion, wherein the central portion, the web portion and the rim portion of the wheel cover comprise a single, integral piece and cooperate to form an outer surface of the cover member. The wheel cover assembly further comprises an attachment assembly adapted to attach to an axle hub bolt and to operably couple the wheel cover member to a wheel, wherein the attachment assembly provides for axial adjustment of the wheel cover member with respect to a wheel, at least one alignment member adapted to abut the web portion of the wheel cover member and a web portion of a wheel, and at least one cushioning member adapted to abut the rim portion of the wheel cover member and a rim portion of a wheel, wherein the rim portion of the wheel cover member is adapted to overlap a rim portion of a wheel to provide a single-piece wheel aesthetic look.

Another aspect of the present invention is to provide a wheel cover bracket assembly for attaching a wheel cover to a wheel, comprising a pair of L-shaped first brackets each adapted to couple to an end of an axle hub by a plurality of hub bolts extending axially outward of an end of an axle hub, and a U-shaped second bracket having a pair of legs linearly-adjustably coupled with the pair of first legs, and a support section extending between the pair of legs and connected to a central portion of a wheel cover, wherein the second bracket is adapted to be located radially inward of a plurality of axle hub bolts.

The present inventive wheel assembly is durable, provides a low manufacturing cost, includes an uncomplicated design, may be assembled with basic tools, and can be easily and quickly assembly by even relatively unskilled operators. The wheel assembly is capable of a long operating life, and is particularly well adapted for the proposed use, specifically for providing a dually-wheel type assembly with an aesthetic look similar to that typically associated with stylized wheels for standard passenger-type vehicles, and provides styling flexibility for such applications. Further, the wheel assembly may be personalized to display particular images, such as company names and logos, operator chosen symbols and the like, and may include a variety of metallic finishes, paint finishes, or combinations thereof.

These and advantages of the invention will be further understood and appreciated by those skilled in the art by reference to the following written specification, claims and appended drawings.

### BRIEF DESCRIPTION OF THE DRAWINGS

FIG. 1 is perspective view of a wheel assembly embodying the present invention; and

FIG. 2 is an exploded perspective view of the wheel assembly.

### DETAILED DESCRIPTION OF THE PREFERRED EMBODIMENTS

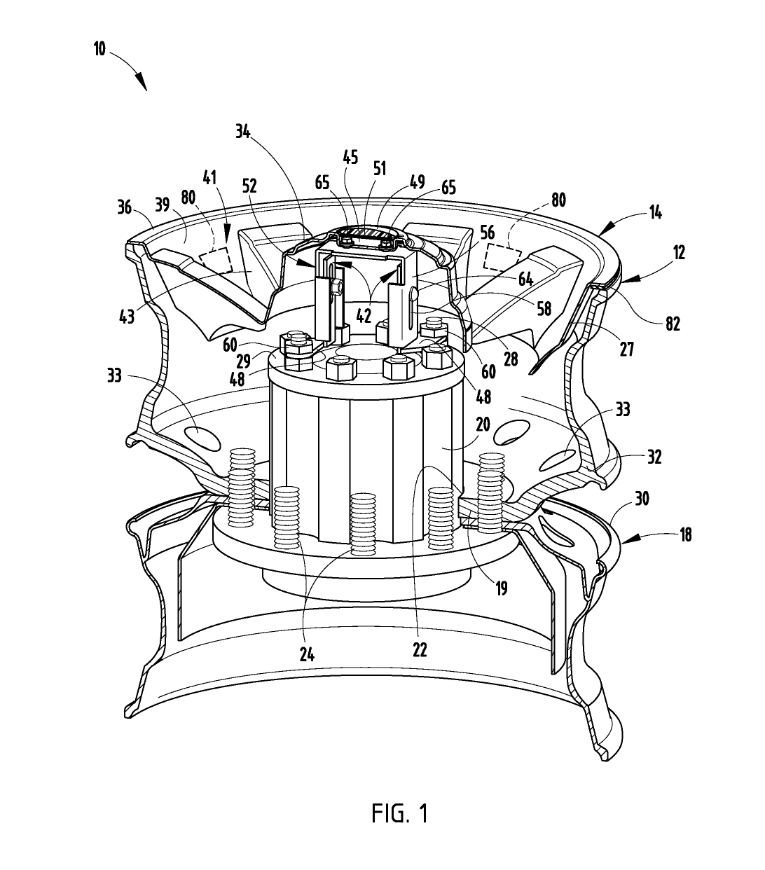

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

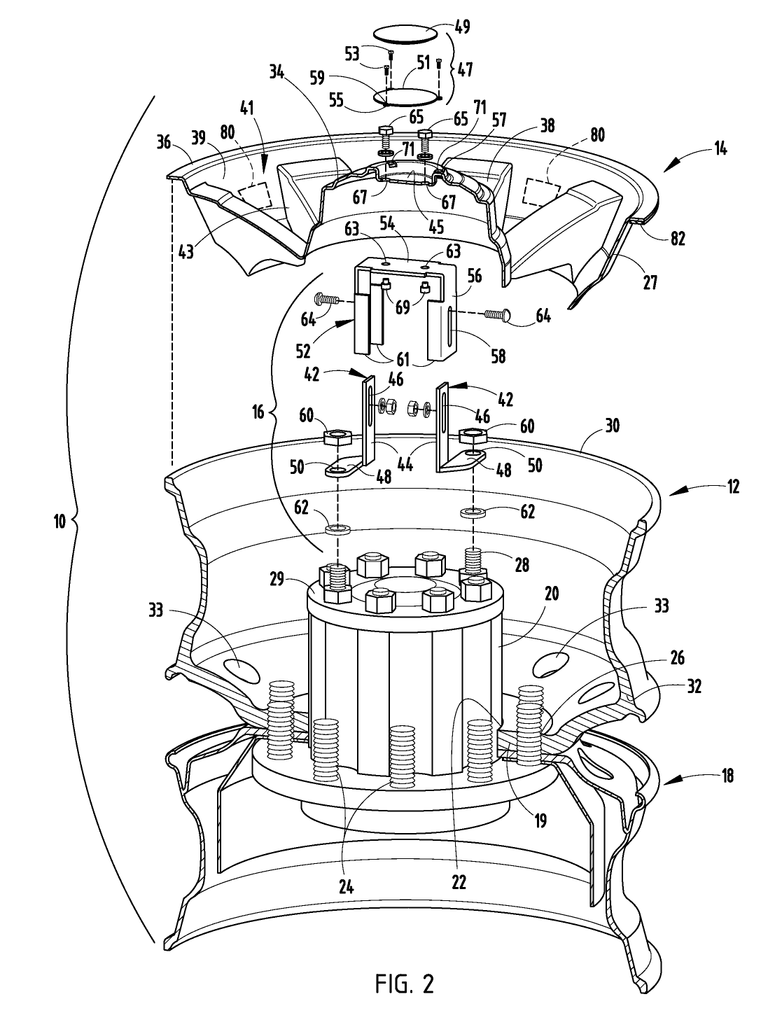

The reference numeral 10 (FIGS. 1 and 2) generally designates a vehicle wheel assembly embodying the present invention. In the illustrated example, the wheel assembly includes a vehicle wheel 12 and a wheel cover 14 attached to the wheel 12 via a wheel cover bracket assembly 16. The wheel assembly 10 is used in conjunction with a dually-wheel assembly that includes the wheel 12 as an outer wheel and inner wheel 18, in an arrangement typically associated with large vehicles, such as heavy duty trucks and trailers, and in particular, vehicles within vehicle weight classifications 1-8, as established by the U.S. Department of Transportation Federal Highway Administration, utilizing a dually-wheel configurations. A central wheel disk or hub portion 19 of the wheel 12 is placed over a vehicle axle hub 20 such that the hub 20 extends through a central aperture 22 of the hub portion 19. Specifically, the hub 20 is surrounded by a plurality of lug bolts 24 that are received within corresponding lug bolt apertures 26 located within the hub portion 19 of the wheel 12, and spaced circumferentially about the central aperture 22. A plurality of hub axle studs 28 extend axially outward from an end 29 of the hub 20 as defined by a hub cover, and are spaced in a circular pattern thereabout. The wheel 12 further includes an outer rim 30 extending circumferentially about the wheel 12, and a web portion 32 extending between the hub portion 19. In the illustrated example, the web portion 32 includes a plurality of apertures 33 extending therethrough, for drainage, weight reduction and/or aesthetic purposes. The wheel 12 is comprised of steel, aluminum, or an alloy adequate for construction of the same.

The wheel cover 14 includes a central portion 34, an outer rim portion 36 circumscribing the wheel cover 14, and a web portion 38 extending between the hub portion 34 and the outer rim portion 36 of the wheel cover 14. The hub portion 34, the rim portion 36 and the web portion 38 of the wheel cover 14 include a single-integral piece that cooperate to form an outer surface 39 of the wheel cover 14. The wheel cover 14 can, of course, comprise numerous materials, including formed aluminum, steel, stainless steel, and combinations thereof, such as metal coated polymeric claddings, such as those exemplified in U.S. Pat. Nos. 5,564,791; 5,577,809; 5,597,213; 5,630,654; 5,636,903; 5,845,973; and 6,085,829, which are incorporated herein by reference in their entirety. Further, an inner surface 27 of the wheel cover 14 may include a glass back finish material resistant to chrome plating, thereby reducing the costs associated with plating the wheel cover 14 and resulting in an inner surface 27 that is more resistant to corrosion. In the illustrated example, the web portion 38 includes a plurality of turbine openings 41 spaced circumferentially thereabout, and defining spokes 43 therebetween, thereby providing an aesthetic appearance similar to those typically associated with wheel assemblies for passenger vehicles. It is noted that the wheel cover 14 may include numerous styling configurations, geographically, and the like typically used in stylized automotive wheels.

The hub portion 34 of the wheel cover 14 includes an axially inwardly-extending recess 45 adapted to receive a lens assembly 47 therein. The lens assembly 47 includes a lens 49 attached to a lens backer 51, which is in turn secured radially outboard of the recess 45 of the wheel cover 14 by a plurality of lens assembly fasteners 53, such as bolts. The lens backer 51 includes a plurality of outwardly-extending tabs 55 that are spaced circumferentially about the periphery of the lens backer 51, and are received within notches 57 extending radially outward from the recess 45, thereby properly aligning and securing the lens backer 51 and lens assembly 47 with the wheel cover 14. Each of the tabs 55 includes an aperture 59 extending therethrough for receiving the fasteners 53 therein, which may either be self-tapping fasteners or may include a bolt and nut arrangement, and be received within apertures 71 located within the notches 57. The lens 49 of the lens assembly 47 is provided with a logo, indicia, or other symbol or verbiage designed for that particular application, and may be easily removed to allow replacement thereof, and/or to allow disassembly of the wheel cover 14 from the wheel 12, as described below. The lens assembly 47 additionally provides a measure of theft deterrence, as described below.

In the illustrated example, the bracket assembly 16 includes a pair of L-shaped first brackets 42 each including a body portion 44 having an elongated slot 46, and a securing portion 48 extending orthogonally from the body portion 44 and including an aperture 50 extending therethrough. The bracket assembly 16 also includes a U-shaped second bracket 52 including a support section 54, and a pair of attachment legs 56 extending orthogonally from the support section 54. Each of the attachment legs 56 includes an elongated slot 58, and a pair of guide walls 61 extending longitudinally therealong. The support section 54 includes a pair of bolt-receiving apertures 63 extending therethrough, as discussed below.

In assembly, each of the first brackets 42 are secured to associated axle hub bolts 28 by jam nuts 60, such that the securing portion 48 of each first bracket 42 is located between adjacent hub bolts 28. It is noted that bushings 62 may be utilized within apertures 50 of the first brackets 44, thereby allowing the brackets 44 to be utilized with various diameter axle hub bolts 28. A pair of lock bolts 64 extend through slots 46, 58 of brackets 42, 52, thereby allowing the second bracket 52 to be secured at various distances along the length of the first brackets 42. A pair of wheel cover mounting bolts and washers 65 are located within the recess 45 of the wheel cover 14, extend through apertures 67 located within the recess 45 and through the apertures 63 of the second bracket 52, and are held in place by associated cinch nuts 69, thereby securing the wheel cover 14 to the bracket assembly 16, and in turn the vehicle and vehicle wheel 12. The linear adjustability between the second bracket 52 and the first brackets 42 allows the bracket assembly 16 to be utilized to secure wheel covers of various shapes, sizes and depths to the associated vehicle and vehicle wheel 12, and to account for axial stack-up tolerance variations from axle hub components, wheel components, bracket components and the like. Specifically, the bracket assembly allows adjustment such that the rim portion 36 of the wheel cover 14 aligns with the outer rim 30 of the wheel 12, and as a result, provides the deep-dish style outer dually-wheel 12 with a relatively more shallow aesthetic appearance, such as those associated with single-wheel applications utilized on typical passenger vehicles. More specifically, the rim portions 36 of the wheel cover 14 aligns with the outer rim 30 of the wheel 12, such that the combination of the wheel 12 and the wheel cover 14 provide an aesthetic appearance of a single-piece wheel construction, e.g., cast aluminum or forged wheels. It is noted that the bridging of the wheel cover area 14 across substantially the entire outer visible surface of the wheel 12, including a wheel rim balance weight flange area, provides a full-surface appearance typically associated with single wheel assemblies. A plurality of foam pads 80 are positioned between the web portion 39 of the wheel cover 14 and the web portion 32 of the wheel 12 and provide proper radial alignment of the wheel cover 14 with respect to the wheel 14, and further cooperate with the bracket assembly 16 to provide radially uniformity of the wheel cover 14 and the wheel 12. The pads 80 also reduce vibrations transmitted from the wheel 12 to the wheel cladding and the vibrational noise associated therewith. A foam insert 82 circumferentially extending about the wheel cover 14 and positioned between the rim portion 36 of the wheel cover 14 and the outer rim 30 of the wheel 12 reduces frictional noise and protects the wheel cover 14 from damage caused by frictional contact between the wheel cover 14 and the wheel 12. The lens assembly 47 is then secured radially outboard of the recess 45, thereby covering the bolts 65 and providing an aesthetic customization to the wheel assembly 10, and further providing a degree of theft deterrence.

The present inventive wheel assembly is durable, provides a low manufacturing cost, includes an uncomplicated design, may be assembled with basic tools, and can be easily and quickly assembled, installed and/or removed by even relatively unskilled operators, thereby allowing for wheel and tire maintenance, and inspections in minimal time. The wheel assembly is capable of a long operating life, and is particularly well adapted for the proposed use, specifically for providing a dually-wheel type assembly with an aesthetic look similar to that typically associated with single-wheel assemblies for standard passenger-type vehicles. Further, the wheel assembly may be personalized to display particular images, such as company names and logos, operator chosen symbols and the like.

In the foregoing description, it will be readily appreciated by those skilled in the art that modifications may be made to the invention without departing from the concepts disclosed herein. Such modifications are to be considered as included in the following claims, unless these claims by their language expressly state otherwise.

We claim:

1. A wheel assembly for attaching to a vehicle hub assembly having an axle hub and a plurality of axle hub bolts extending axially from an end of the axle hub in a substantially circular pattern, the wheel assembly comprising:
a wheel having a centrally located aperture for receiving an axle hub therethrough, a hub portion including a plurality of lug bolt receiving apertures adapted to receive a plurality of lug bolts therein to secure the wheel assembly to an associated vehicle, a rim portion extending circumferentially about the wheel, and a web portion extending between the hub portion and the rim portion, wherein the hub portion, the rim portion and the web portion of the wheel cooperate to form an outer surface of the wheel;
a wheel cover member having an inner surface facing the outer surface of the wheel, a central portion covering the centrally located aperture of the wheel, a rim portion extending circumferentially about the cover member, and a web portion extending between the central portion and the rim portion of the cover member, wherein the central portion, the rim portion and the web portion of the cover member comprise a single, integral piece and cooperate to form an outer surface of the cover member, and wherein the rim portion of the cover member radially overlaps the rim portion of the wheel such that the wheel cover and the wheel cooperate to provide the aesthetic appearance of a single-piece wheel; and
an attachment assembly attached to the axle hub bolts and operably coupling the wheel cover member with the wheel, wherein the attachment assembly provides for an axial adjustment of the wheel cover member with respect to the wheel.

2. The wheel assembly of claim 1, further including:
at least one alignment member positioned between the wheel and the wheel cover member and radially aligning the wheel cover member with respect to the wheel.

3. The wheel cover assembly of claim 2, wherein the at least one alignment member includes a plurality of foam pads spaced circumferentially about the wheel cover member and positioned between the web portion of the wheel and the web portion of the wheel cover member.

4. The wheel assembly of claim 1, further including:
a cushioning member located between the rim portion of the wheel and the rim portion of the wheel cover member.

5. The wheel assembly of claim 1, wherein the cushioning member comprises a foam pad.

6. The wheel assembly of claim 1, wherein the attachment assembly includes at least one first bracket attached to the axle hub bolts and at least one second bracket attached to the central portion of the wheel cover member, wherein the at least one second bracket is operably coupled with the at least one second bracket and is linearly adjustable with respect thereto.

7. The wheel assembly of claim 1, wherein the at least one first bracket includes an aperture having a diameter and extending therethrough for receiving an axle hub bolt; and further including:
a spacer member located within the aperture of the at least one first bracket and having an inner diameter that is less than the diameter of the aperture of the at least one first bracket, wherein the spacer member is adapted to fill a space between the aperture of the at least one first bracket and an axle hub bolt.

8. The wheel assembly of claim 1, wherein the wheel cover member includes an axially extending recess within the central portion; and further including:
a removable aesthetic insert positioned within the recess.

9. The wheel assembly of claim 1, wherein the removable aesthetic insert is secured within the recess by at least one mechanical fastener.

10. A wheel cover assembly for covering a vehicle wheel and a vehicle hub assembly that includes an axle hub and a plurality of axle hub bolts extending axially from an end of the axle hub in a substantially circular pattern, the wheel cover assembly comprising:
a wheel cover member having an inner surface adapted to face an outer surface of a vehicle wheel, a central portion adapted to cover a centrally located aperture of a wheel that receives an axle hub therethrough, a web portion circumscribing the central portion, and a rim portion extending circumferentially about the rim portion, wherein the central portion, the web portion and the rim portion of the wheel cover comprise a single, integral piece and cooperate to form an outer surface of the cover member;
an attachment assembly adapted to attach to an axle hub bolt and to operably couple the wheel cover member to a wheel, wherein the attachment assembly provides for axial adjustment of the wheel cover member with respect to a wheel;
at least one alignment member adapted to abut the web portion of the wheel cover member and a web portion of a wheel and radially aligns the same;
at least one cushioning member adapted to abut the rim portion of the wheel cover member and a rim portion of a wheel; and
wherein the rim portion of the wheel cover member is adapted to radially overlap a rim portion of a wheel to provide a single-piece wheel aesthetic appearance.

11. The wheel cover assembly of claim 10, wherein the at least one alignment member includes a plurality of foam pads circumferentially spaced about the wheel cover member.

12. The wheel cover assembly of claim 10, wherein the cushioning member includes a foam cushion.

13. The wheel cover assembly of claim 10, wherein the attachment assembly includes at least one first bracket adapted to attach to a hub axle bolt and at least one second bracket adapted to attach to the central portion of the wheel cover assembly, and wherein the at least one first bracket is linearly adjustable with respect to the at least one second bracket.

14. The wheel cover assembly of claim 10, wherein the at least one first bracket includes an aperture having a diameter and extending therethrough for receiving an axle hub bolt; and further including:
a spacer member located within the aperture of the at least one first bracket and having an inner diameter that is less than the diameter of the aperture of the at least one first bracket, wherein the spacer member is adapted to fill a space between the aperture of the at least one first bracket and an axle hub bolt.

15. The wheel cover assembly of claim 10, wherein the wheel cover member includes an axially extending recess within the central portion; and further including:
a removable aesthetic insert positioned within the recess.

16. The wheel assembly of claim 10, wherein the removable aesthetic insert is secured within the recess by at least one mechanical fastener.
